(19) United States
(12) Patent Application Publication
(10) Pub. No.: US 2014/0152593 A1
(43) Pub. Date: Jun. 5, 2014

(54) Method And System For Operating Portable Devices

(71) Applicant: Industrial Technology Research Institute, Chutung (TW)

(72) Inventors: Chih-Hung Wu, New Tapei City (TW); Po-Wei Lin, Kaohsiung City (TW); Chien-Ju Lee, Taoyuan City (TW); Chien-Chih Hsu, Tongxiao Township (TW)

(73) Assignee: Industrial Technology Research Institute, Chutung (TW)

(21) Appl. No.: 14/048,993

(22) Filed: Oct. 8, 2013

Related U.S. Application Data
(60) Provisional application No. 61/732,681, filed on Dec. 3, 2012.

(51) Int. Cl. G06F 3/041

(52) U.S. Cl. CPC G06F 3/041
USPC 345/173

(57) ABSTRACT

A method for providing a one-hand user interface for a portable device with a touch screen including defining a one-hand operation plane on the touch screen based on a holding location of the portable device when operated by a user; enabling a one-hand operation mode; and receiving user inputs through the one-hand operation plane for controlling the portable device.

### RELATED APPLICATION

This application is based upon and claims the benefit of priority from Provisional Application No. 61/732,681, filed Dec. 3, 2012, the entire contents of which are incorporated herein by reference.

### TECHNICAL FIELD

This disclosure in general relates to methods and systems for operating portable devices having touch screens and, more particularly, to methods and systems for providing a one-hand user interface for a portable device.

### BACKGROUND

Touch screens have been widely used in various kinds of portable devices, such as global positioning systems (GPS), smart phones, tablet PCs, and E-readers, etc. With touch screens, users can easily operate their portable devices by pressing graphical user interfaces (GUIs) (such as virtual keypads, or graphical icons) displayed on the touch screens. Accordingly, conventional accessories or peripheral components, such as computer mice, physical keypads, and push-buttons, etc., are no longer required.

FIG. 1 illustrates a portable device 100 with a small touch screen 110. A user can operate portable device 100 with one hand because small touch screen 110 allows the user to hold portable device 100 and move his/her thumb to press, with one hand, all GUIs 120 (shown in blocks) displayed on small touch screen 110.

Nowadays, portable devices with large touch screens become more and more popular because large screens provide better user experience in browsing Internet, watching movies, and reading e-mails, etc. Because of the size of the touch screen, however, it is difficult for a user to operate, with only one hand, a portable device with a large touch screen, as there may be some GUIs on the touch screen that the user cannot touch with the same hand holding the portable device. Accordingly, as illustrated in FIG. 2, a user may need to hold, with one hand, a portable device 200 with a large touch screen 210 and operate portable device 200 with the other hand. Alternatively, the user may need to lay portable device 200 on a flat surface or a supporting device, such as a supporting structure 310 shown in FIG. 3, in order to operate portable device 200 with one hand.

The solutions Illustrated in FIGS. 2 and 3 may not be feasible when, for example, the user is standing on a moving bus, or when the user is handicapped. Therefore, it is desirable to provide a method for operating portable devices having large touch screens so that, even when users have only one free hand, they can still properly operate their portable devices.

SUMMARY

In accordance with embodiments of the present disclosure, there is provided a method for providing a one-hand user interface for a portable device with a touch screen. The method includes defining a one-hand operation plane on the touch screen based on a holding location of the portable device when operated by a user; enabling a one-hand operation mode; and receiving user inputs through the one-hand operation plane for controlling the portable device.

Also in accordance with embodiments of the present disclosure, there is provided a portable device system including a touch screen; a memory that stores at least one parameter for a one-hand operation mode; and a processor coupled to the touch screen and the memory. The processor is configured to define a portion of the touch screen as a one-hand operation plane based on a holding location of the portable device system; enable a one-hand operation mode based on the at least one parameter for the one-hand operation; and receive user inputs through the one-hand operation plane for operating the portable device system.

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates a portable device;

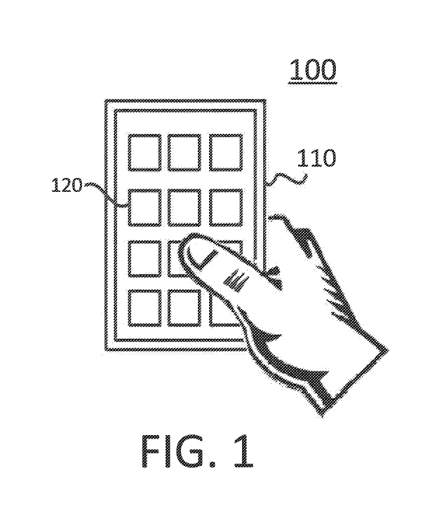

FIG. 2 illustrates another portable device;

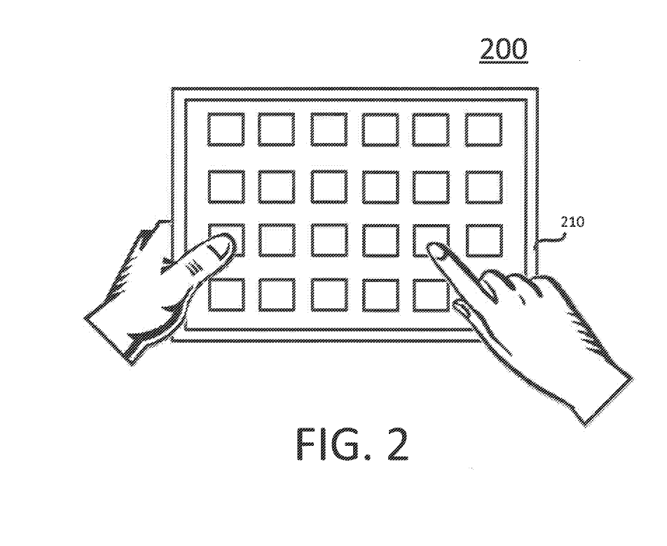

FIG. 3 illustrates still another portable device;

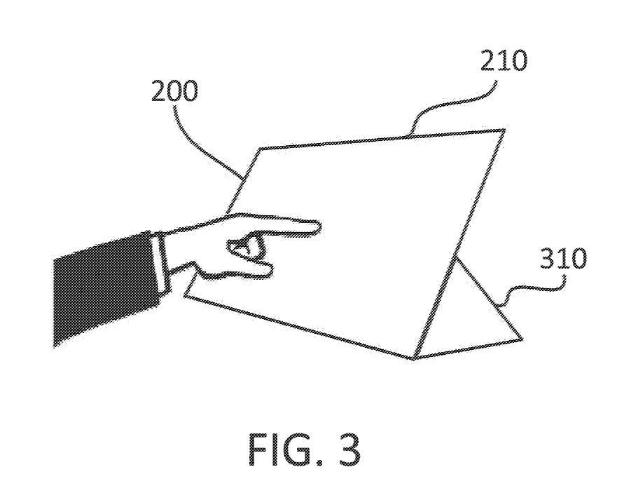

FIG. 4 shows a flow chart illustrating a method for operating a portable device having a touch screen with one hand, according to an exemplary embodiment of the present disclosure;

FIG. 5A illustrates an exemplary one-hand operation plane defined on a touch screen of a portable device, according to an exemplary embodiment of the present disclosure;

FIG. 5B illustrates an alternative method for defining a one-hand operation plane on a touch screen of a portable device, according to another exemplary embodiment of the present disclosure;

FIG. 5C illustrates an alternative method for defining a one-hand operation plane on a touch screen of a portable device, according to another exemplary embodiment of the present disclosure;

FIG. 5D illustrates an alternative method for defining a one-hand operation plane on a touch screen of a portable device, according to another exemplary embodiment of the present disclosure;

FIG. 5E illustrates a portable device operating in a one-hand touchpad operation mode according to an exemplary embodiment of the present disclosure;

FIG. 5F illustrates a process of defining a one-hand operation plane for the one-hand touchpad operation mode, according to an exemplary embodiment of the present disclosure;

FIG. 6 illustrates, as an example, a portable device in a one-hand GUI operation mode, according to an exemplary embodiment of the present disclosure;

FIG. 7 illustrates, as an example, a portable device in a one-hand touchpad operation mode, according to an exemplary embodiment of the present disclosure;

FIG. 8 illustrates an example where the one-hand operation plane changes with the holding location of the user, according to an exemplary embodiment of the present disclosure; and

FIG. 9 illustrates a functional block diagram of a portable device system having a touch screen that allows users to operate the portable device system with one hand, according to an exemplary embodiment of the present disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of systems and methods consistent with aspects related to the disclosure as recited in the appended claims.

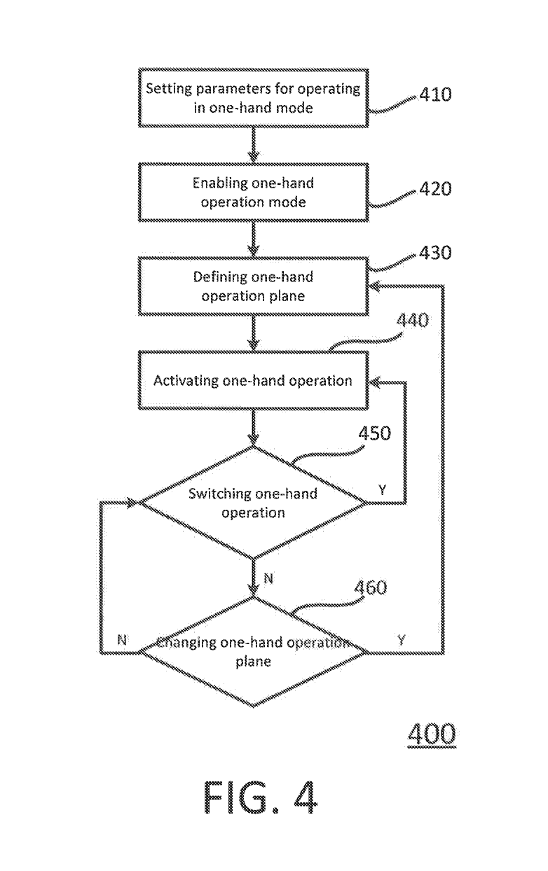

FIG. 4 shows a flow chart illustrating a method 400 for operating a portable device having a touch screen by a user using one hand, according to an exemplary embodiment of the present disclosure. More particularly, method 400 consistent with embodiments of the present disclosure provides a one-hand operation mode for the portable device with a touch screen. Method 400 can be implemented in any portable device, such as global positioning system (GPS) devices, smart phones, tablet PCs, and E-readers. etc. According to another embodiment, the portable device suitable for implementations of method 400 has a relatively large touch screen, so that the user's hand holding the portable device is unable to access the entire area of the touch screen.

Referring to FIG. 4, first, parameters for operating a portable device having a touch screen in the one-hand operation mode are set (Step 410). The parameters may define a portion of the touch screen, number of GUIs, etc., which can be operated by the user using one hand. Consistent with one exemplary embodiment, the parameters corresponding to the one-hand operation mode may be set by a manufacturer of the portable device and/or by a service provider. Consistent with another exemplary embodiment of the present disclosure, a user may be provided with the option of setting the parameters for the one-hand mode of operation. More specific examples and detailed discussions of the functions of the parameters will be provided below.

Referring back to FIG. 4, once the parameters are set, the one-hand operation mode is enabled (Step 420). Consistent with one embodiment, the user may enable the one-hand operation mode by pressing a specific GUI displayed on the touch screen, pushing a physical key or button disposed on the portable device, and/or selecting an option within a list or a menu displayed on the touch screen.

Consistent with another exemplary embodiment of the present disclosure, the step of setting the parameters corresponding to the one-hand operation mode (Step 410) may be performed after the step of enabling the one-hand operation mode of the portable device (Step 420).

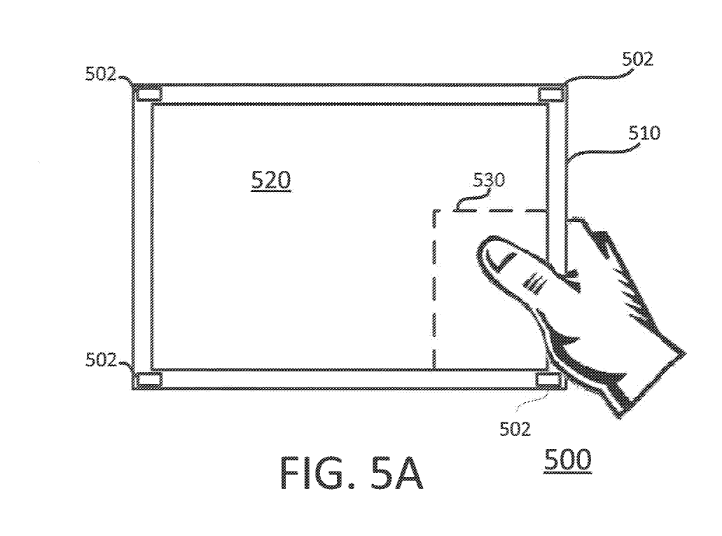

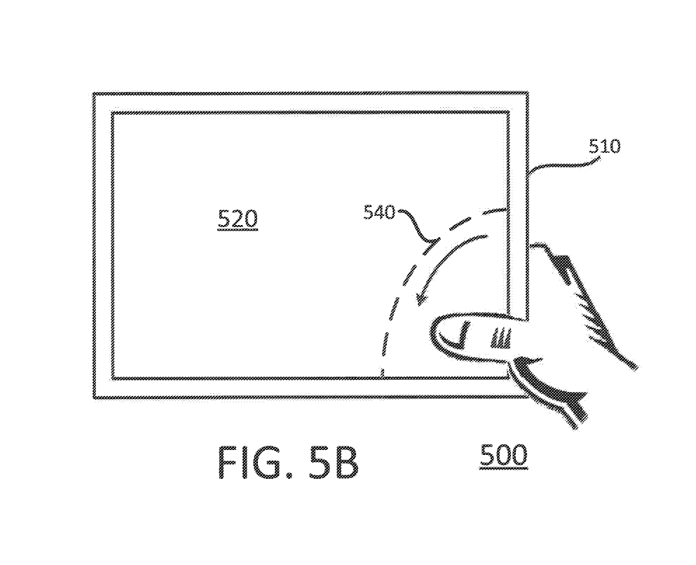

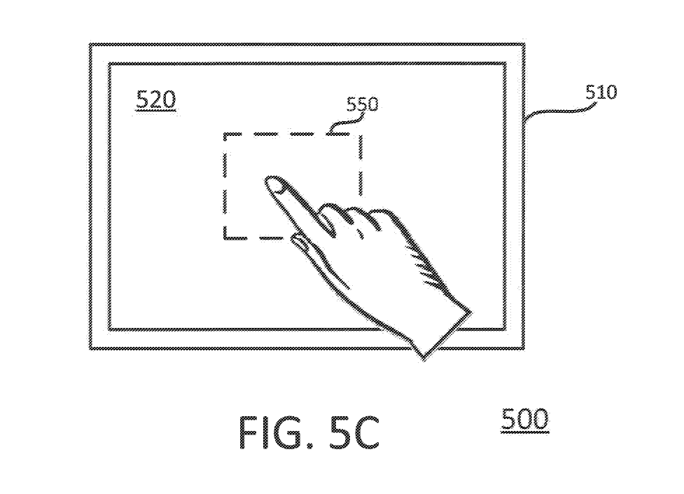

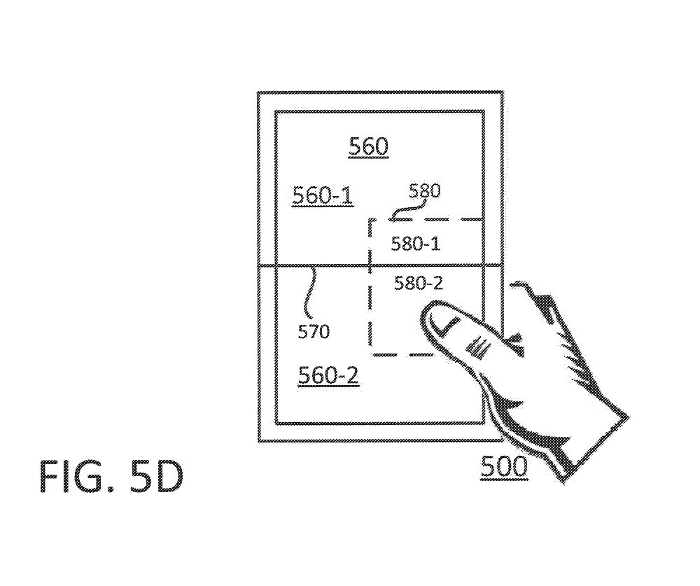

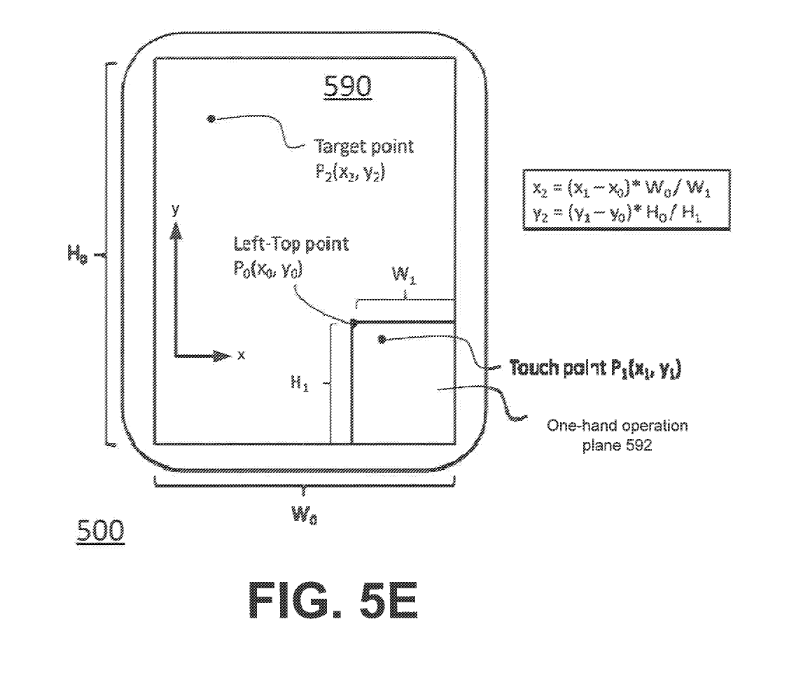

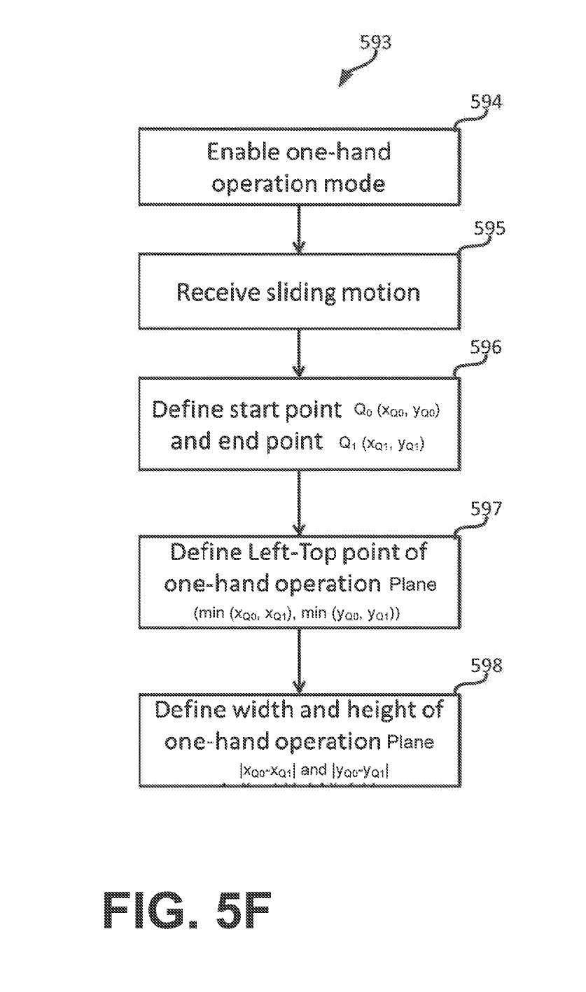

Consistent with an embodiment of the present disclosure, in Step 430, a one-hand operation plane, such as a portion of the touch screen suitable for one-hand operation, may be defined. FIG. 5A illustrates an exemplary one-hand operation plane 530 defined on a touch screen 520 of a portable device 500. For example, one-hand operation plane 530 may be located proximate to a portion of portable device 500 held by a user or a holding location of touch screen 520 at which the user holds portable device 500.

Consistent with an exemplary embodiment of the present disclosure, the holding location is detected by detecting a location where a finger of the user's hand presses on touch screen 520. Consistent with another exemplary embodiment of the present disclosure, the holding location is detected by one or more sensors of portable device 500. The sensors may be pressure detectors, touch sensor, IR sensors, thermal sensors, or any other suitable sensors known in the art. FIG. 5A shows, as an example, four pressure detectors 502 embedded within one or more corners of frame 510 of portable device 500. Pressure detectors 502 are capable of detecting pressure at any location of frame 510 of touch screen 520. Thus, through pressure detectors 502, the holding location of the user can be determined.

Consistent with an exemplary embodiment of the present disclosure, the parameters set in Step 410 may define a one-hand operation plane 530 such that the entirety of one-hand operation plane 530 is touchable or accessible by a finger of the user's hand holding portable device 500. The parameters may include a size, a length, a width, and/or a shape of one-hand operation plane 530.

FIG. 5B illustrates an alternative method for determining a one-hand operation plane 540 on touch screen 520 of portable device 500, according to an exemplary embodiment of the present disclosure. In particular, the user may slide a finger to define both the location and size of one-hand operation plane 540.

FIG. 5C illustrates an alternative method for determining a one-hand operation plane 550 on touch screen 520 of portable device 500, according to an exemplary embodiment of the present disclosure. In particular, the user may choose or designate, by touching touch screen 520, any portion of touch screen 520 as a one-hand operation plane 550, which may or may not border frame 510. The size and shape of one-hand operation plane 550 may be set by a manufacturer of portable device 500, a service provider, or the user. Once the one-hand operation plane 550 is determined, portable device 500 is configured to receive press or touch inputs through one-hand operation plane 550. Portable device 500 may ignore any press or touch that occurs outside of one-hand operation plane 550. According to a further embodiment, portable device 500 allows the user to change the location, size, or shape of one-hand operation plane 550 as desired.

According to a further embodiment, portable device 500 may automatically adjust the location, size, or shape of one-hand operation plane 550 according to an orientation of portable device 500. For example, portable device 500 includes an orientation sensor or accelerometer that senses the orientation of portable device 500 with respect to the Earth's gravity. The orientation sensor generates an orientation signal indicating the orientation of portable device 500. Based on the orientation signal from the orientation sensor, portable device 500 determines whether it has been rotated in a plane of touch screen 520. If portable device 500 has been rotated, portable device 500 adjusts the location of one-hand operation plane 550 so that a different portion of touch screen 520 becomes one-hand operation plane 550. As such, portable device 500 maintains one-hand operation plane 550 at, for example, the lower-right corner of touch screen 520 even when the orientation of portable device 500 is changed. Thus, the user is not required to change the motions of his/her hand in a significant way in order to properly operate portable device 500.

According to an alternative embodiment as shown in FIG. 5D, method 400 may be implemented on portable device 500 having a foldable touch screen 560 to allow the user to operate portable device 500 using one hand. In particular, when not in use, touch screen 560 may be folded along a dividing line 570, which divides touch screen 560 into a first portion 560-1 and a second portion 560-2. When touch screen 560 is unfolded, first portion 560-1 and second portion 560-2 are configured to receive user inputs through press and touch. In this embodiment, a one-hand operation plane 580 may be defined within first portion 560-1 alone, second portion 560-2 alone, or across dividing line 570 within first portion 560-1 and second portion 560-2. Portable device 500 is configured to receive user inputs through one-hand operation plane 580.

According to a further embodiment, at least a portion of one-hand operation plane 580 is defined on one of first portion 560-1 or second portion 560-2 and is used to control icons, cursors, or other interface elements rendered on the other one of first portion 560-1 or second portion 560-2. For example, as shown in FIG. 5D, one-hand operation plane 580 includes a first area 580-1 defined within first portion 560-1 of touch screen 560 and a second area 580-2 defined within second portion 560-2 of touch screen 560. Second area 580-2 of one-hand operation plane 580 is configured to detect pressing or touching by the user within the area and control icons, cursors, or other interface elements rendered on first portion 560-1 of the touch screen according to the pressing or touching. Alternatively, first area 580-1 of one-hand operation plane 580 may be configured to detect the pressing or touching by the user within the area and control icons, cursors, or other interface elements rendered on second portion 560-2 of the touch screen according to the pressing or touching. As a result, first area 580-1 and second area 580-2 serve as touchpads for second portion 560-2 and first portion 560-1, respectively.

According to a further embodiment, portable device 500 may automatically adjust the location, size, or shape of one-hand operation plane 580 according to a folding angle between first portion 560-1 and second portion 560-2. In this embodiment, portable device 500 includes an angular sensor for detecting the folding angle between first portion 560-1 and second portion 560-2. When touch screen 560 is completely unfolded, resulting in a folding angle of 180 degrees between first portion 560-1 and second portion 560-2, portable device 500 defines a relatively large portion of touch screen 520 to be one-hand operation plane 580. Accordingly, one-hand operation plane 580 may cross dividing line 570 or cover an entire area of first portion 560-1 or second portion 560-2.

When touch screen 560 is partially folded, resulting in a folding angle less than 180 degrees between first portion 560-1 and second portion 560-2, portable device 500 may adjust the size of one-hand operation plane 580, move one-hand operation plane 580, or change the shape of one-hand operation plane 580. For example, portable device 500 may deactivate the area of one-hand operation plane 580 within the first portion 560-1 or the second portion 560-2, thereby reducing the area of one-hand operation plane 580 to one side of dividing line 570 in response to restricted accessibility of touch screen 520 caused by the folding. Portable device 500 may also maintain the size and shape of one-hand operation plane 580, while relocating one-hand operation plane 580 to one side of dividing line 570. Portable device 500 may also move one-hand operation plane 580 from an interior area of touch screen 560 to a border area of touch screen 520, so as to allow the user to control portable device 500 using one hand even when touch screen 520 is partially folded.

Consistent with an exemplary embodiment of the present disclosure, after one-hand operation plane 530 (FIG. 5A) or 540 (FIG. 5B) is defined, the “touch” function may be enabled only within one-hand operation plane 530 or 540 of touch screen 520 but disabled outside one-hand operation plane 530 or 540. Thus, portions of touch screen 520 outside one-hand operation plane 530 or 540 do not respond to any press, touch, or motion. Such partial disablement of the touch function during the one-hand operation mode avoids unintended actions caused by accidental touch or press in such areas other than one-hand operation plane 530 or 540.

Referring back to FIG. 4, consistent with an exemplary embodiment of the present disclosure, after one-hand operation plane 530 or 540 is defined, the one-hand operation is activated (Step 440). When portable device 500 performs the one-hand operation, the user may control the operation of portable device 500 with one hand.

Consistent with an exemplary embodiment of the present disclosure, the one-hand operation is activated by pushing a physical key or button disposed on portable device 500. Consistent with another embodiment of the present disclosure, the one-hand operation is activated by pressing a corresponding GUI. The GUI may, for example, automatically appear within one-hand operation plane 530 after one-hand operation plane 530 is defined.

Consistent with an exemplary embodiment, the one-hand operation performed by portable device 500 may be in either a one-hand GUI operation mode or a one-hand touchpad operation mode. In the one-hand GUI operation mode, one or more GUIs are provided in the one-hand operation plane (e.g., 530, 540, 550, and 580), whereas in the one-hand touchpad operation mode, the one-hand operation plane operates as a touch pad.

FIG. 5E depicts another embodiment of portable device 500 including a touch screen 590 with a width W₀ and a height H₀. Touch screen 590 includes a one-hand operation plane 592 that operates as a touchpad in the one-hand touchpad operation mode. One-hand operation plane 592 is defined on touch screen 590 according to the procedures discussed above in connection with FIGS. 5A-5D and is further described hereinafter. One-hand operation plane 592 has a width W₁ and a height H₁. W₀, H₀, W₁ and H₁ may be defined in inches, mm, pixels, or any other units known in the art.

In addition, an x-y coordinate system is associated with touch screen 590. The x-y coordinate system includes an x axis and a y axis that are perpendicular to each other. The x axis and the y axis may be aligned with the edges of touch screen 590. As a result, a point on touch screen 590 is identified by coordinates (x, y) with respect to the x-y coordinate system. One-hand operation plane 592 may be identified by a reference point, such as the top-left point P₀ (x₀, y₀) as depicted in FIG. 5E.

In the one-hand touchpad operation mode, portable device 500 may detect a point of pressing or touching (i.e., a point of contact) within the boundary of one-hand operation plane 592 and translate the point of contact to a corresponding point on touch screen 590 for controlling a cursor, an icon, or other interface elements rendered thereon. For illustrative purposes, as shown in FIG. 5E, it is assumed that portable device 500 detects the point of contact within one-hand operation plane 592 at a touch point P₁ (x₁, y₁). Device 500 then translates the touch point P₁ to a target point P₂ (x₂, y₂) on touch screen 590 according to the following equations:

x₂=(x₁−x₀)W₀/W₁;

y₂=(y₁−y₀)H₀/H₁.

Upon determining the target point P₂, device 500 may, for example, move a cursor to the target point P₂. When the user further presses on touch point P₁ or taps on touch point P₁, device 500 may initiate an application identified by an icon rendered at the target point P₂, activate a button rendered at the target point P₂, check/uncheck a radio button rendered at the target point P₂, etc.

FIG. 5F depicts a process 593 for defining the one-hand operation plane 592 depicted in FIG. 5E for the one-hand touchpad operation mode, according to one embodiment. According to process 593, at step 594, portable device 500 enables the one-hand operation mode. At step 595, portable device 500 detects and receives a sliding motion by the user. At step 596, portable device 500 defines a start point Q₀ of the sliding motion identified by coordinates (x_{Q0}, y_{Q0}) and an end point Q₁ of the sliding motion identified by coordinates (x_{Q1}, y_{Q1}). At step 597, portable device 500 defines the coordinates of the top-left point P₀ of the one-hand operation plane 592 according to the following formula:

(min(x_{Q0},x_{Q1}),min(y_{Q0},y_{Q1})),

where min( ) represents a minimization operation. At step 598, portable device 500 defines the width W₁ and the height H₁ of the one-hand operation plane 592 according to the following equations:

W₁=|x_{Q0}−x_{Q1}|;

H₁=|y_{Q0}−y_{Q1}|.

Consistent with an exemplary embodiment of the present disclosure, the one-hand GUI operation mode and the one-hand touchpad operation mode may be selected or determined in Step 420 when the one-hand operation mode is enabled. Consistent with an alternative exemplary embodiment of the present disclosure, the one-hand GUI operation mode and the one-hand touchpad operation mode may be selected or determined in Step 440 when the one-hand operation is activated.

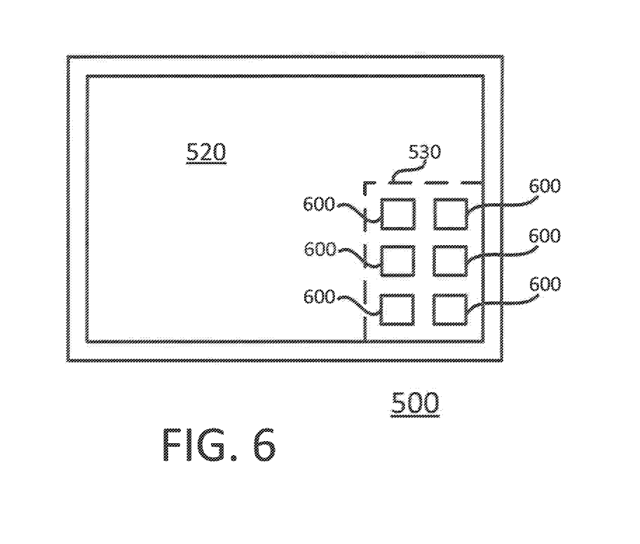

FIG. 6 illustrates, as an example, portable device 500 in the one-hand GUI operation mode, according to an exemplary embodiment of the present disclosure. In particular, GUIs 600 are displayed within one-hand operation plane 530, and the user may operate portable device 500 by pressing particular GUIs 600 within one-hand operation plane 530 with one hand. GUIs 600 may correspond to the programs (or applications) that the user most frequently uses. In one aspect, GUIs 600 correspond to programs or applications identified as the most frequently used programs within a certain past time period. In another aspect, the parameters set in Step 410 include the past time period, a threshold of frequency of use, and the number of GUIs 600 to be displayed within the one-hand operation plane.

Consistent with another exemplary embodiment of the present disclosure, when portable device 500 is in the one-hand GUI operation mode, GUIs 600 are selected based on the program (or the application) being executed before portable device 500 enters the one-hand operation mode. For example, if portable device 500 was playing a movie right before entering the one-hand operation mode, GUIs 600 may relate to movie-playing functions, such as “Play,” “Stop,” “Pause,” “Forward,” or “Reverse” functions. Consistently, the parameters set in Step 410 may include the GUIs corresponding to each of the programs (or applications) of portable device 500 and the number of GUIs 600 to be displayed within the one-hand operation plane.

Consistent with still another exemplary embodiment of the present disclosure, after the one-hand GUI operation mode is enabled, the user may further select a specific function, such as photo-shooting, movie-playing, internet-browsing, e-mail checking/replying, etc. GUIs 600 may correspond to the selected function. In this embodiment, all the GUIs are categorized in advance based on the functions that portable device 500 can perform. Consistently, the parameters set in Step 410 may include the categorization of the GUIs.

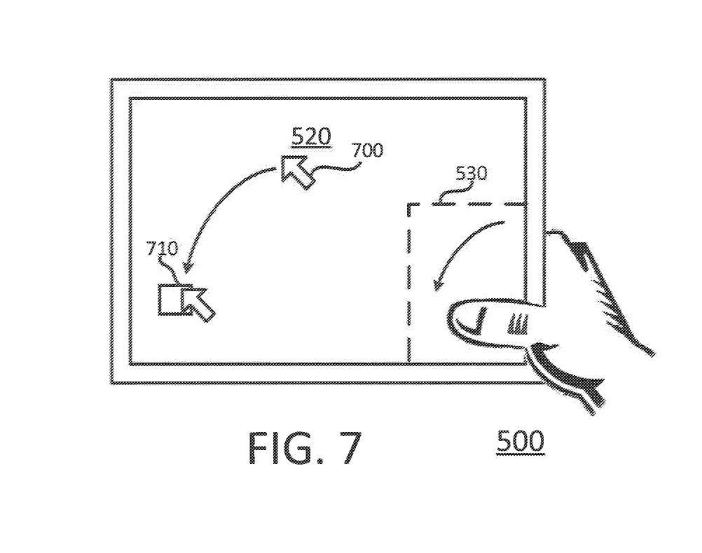

FIG. 7 illustrates, as an example, portable device 500 in the one-hand touchpad operation mode, according to an exemplary embodiment of the present disclosure. In particular, one-hand operation plane 530 becomes a touchpad for the user to control the operation of portable device 500. As shown in FIG. 7, when portable device 500 is in the one-hand touchpad operation mode, the user may control movements of a cursor 700 displayed on touch screen 520 by sliding a finger over one-hand operation plane 530. For example, cursor 700 may move on touch screen 520 along a path corresponding to a sliding path of the user's finger on one-hand operation plane 530. In addition, the one-hand touchpad operation also allows the user to “click” GUI 710 by pressing his/her finger in an area of one-hand operation plane 530 after cursor 700 is moved to overlap with GUI 710. Accordingly, one-hand operation plane 530 functions as a touchpad. In this embodiment, the parameters set in Step 410 may include an initial location of cursor 700 on touch screen 520, a correspondence between the sliding of the finger on one-hand operation plane 530 and the movements of cursor 700 on touch screen 520.

Referring back to FIG. 4, consistent with an exemplary embodiment of the present disclosure, the user may switch the operation of portable device 500 between the one-hand GUI operation mode and the one-hand touchpad operation mode (Step 450). The user may do so by pushing a physical key or button disposed on portable device 500. Alternatively, the user may perform a specific move, such as a “double press” in one-hand operation plane 530, to invoke a GUI within one-hand operation plane 530 corresponding to switching the one-hand operation. Then, the user may press the GUI to switch between the one-hand GUI operation mode and the one-hand touchpad operation mode.

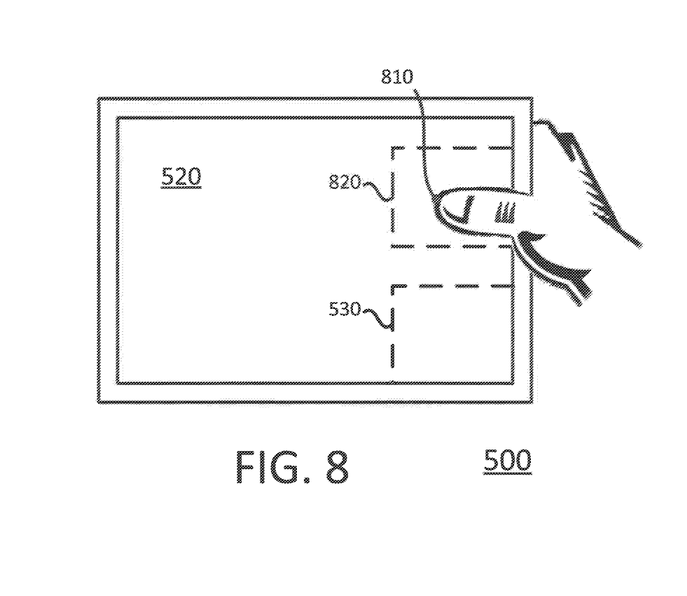

Consistent with an exemplary embodiment of the present disclosure, the location of the one-hand operation plane on the touch screen can be dynamically changed when the user's holding location is changed (Step 460). FIG. 8 illustrates an example where the one-hand operation plane changes with the holding location. In one embodiment, when portable device 500 detects that a specific point 810 corresponding to a new holding location on touch screen 520 has been pressed for a period of time, portable device 500 treats this event as the user's finger pressing specific point 810 and may determine a new location of the one-hand operation plane, e,g., plane 820, according to the new holding location of specific point 810. If the detection of the user's holding location is implemented with pressure detectors 502 as shown in FIG. 5A, the new holding location may be detected by pressure detectors 502 using the same method described above. When detecting a pressure applied to the touch screen by the user at the new holding location, one or more of pressure detectors 502 may generate a pressure signal indicating the detected pressure.

In another embodiment, when portable device 500 detects changes in outputs from pressure detectors 502 and determines that the changes exceed a threshold value, portable device 500 treats this event as the user's intent to adjust the one-hand operation plane. A newly defined one-hand operation plane 820 may be arranged along the same edge of frame 510 as original one-hand operation plane 530 or along a different edge of frame 510. The dynamic changes of the one-hand operation plane may be performed at Step 420 described above. Portable device 500 may periodically monitor the user's hand motions and the outputs from pressure detectors 502 to determine whether the adjustment is desired.

Consistent with another exemplary embodiment of the present disclosure, when portable device 500 detects a new holding location corresponding to specific point 810, a dialogue box with “Yes” and “No” icons may be displayed on one-hand operation plane 530 for the user to confirm that he/she would like to change from one-hand operation plane 530 to new one-hand operation plane 820. If the user chooses “Yes,” then one-hand operation plane 820 is defined according to the new holding location and portable device 500 switches to new one-hand operation plane 820. If the user chooses “No,” the user continues to operate portable device 500 in one-hand operation plane 530.

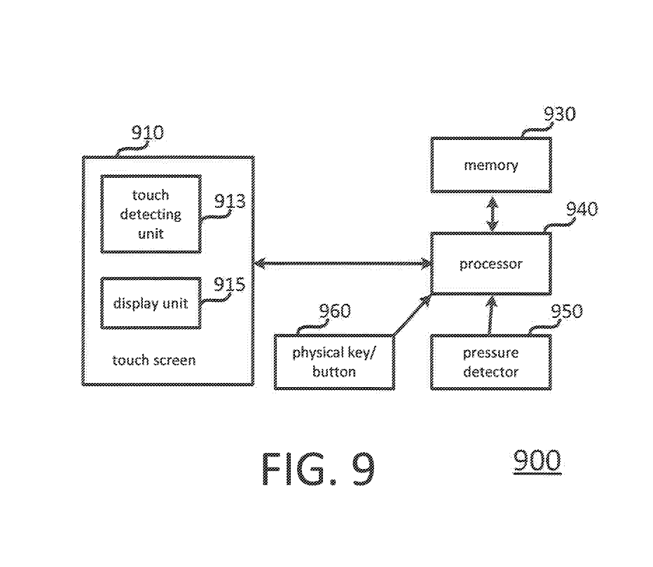

FIG. 9 illustrates a functional block diagram of a portable device system 900 that allows users to operate, with one hand, portable device system 900 having a touch screen 910, according to an exemplary embodiment of the present disclosure. Portable device system 900 includes touch screen 910 that further includes a touch detecting unit 913 for detecting a user's holding location and a display unit 915 for displaying images such as GUIs, a memory 930 for storing the parameters corresponding to the one-hand operation mode, and a processor 940 coupled to memory 930 and touch screen 910 for controlling the operation of portable device system 900. Consistent with an exemplary embodiment of the present disclosure, by executing computer program instructions, processor 940 is configured to control portable device system 900 to perform the method and functions according to the above exemplary embodiments of the present disclosure.

Consistent with an exemplary embodiment of the present disclosure, portable device system 900 further includes at least one pressure detector 950 coupled to processor 940 for detecting the user's holding location. Consistent with another exemplary embodiment of the present disclosure, portable device system 900 further includes at least one physical key and/or button 960 coupled to processor 940, which, when pushed, causes processor 940 to enable the one-hand operation mode, activate the one-hand operation (either the GUI operation or the touchpad operation), and/or switch the one-hand operation (between the one-hand GUI operation mode and the one-hand touchpad operation mode).

Referring to FIG. 9, when parameters corresponding to the one-hand operation mode are set either by portable devices manufacturers/providers or users (Step 410), those parameters are stored in memory 930. When a user pushes a physical key/button 960 or presses a GUI displayed on touch screen 910, or selects an option with a list or a menu displayed on touch screen 910 to enable the one-hand operation mode of portable device system 900, touch screen 910 or physical key/button 960 sends a one-hand operation mode enabling signal to processor 940. After receiving the one-hand operation mode enabling signal, processor 940 enables the one-hand operation mode of portable device system 900 (Step 420).

After the one-hand operation mode is enabled, the user's holding location is detected by either touch detecting unit 913 or pressure detector 950. Then, touch screen 910 or pressure detector 950 sends a detection signal to processor 940. Processor 940, after receiving the detection signal, determines the location of the one-hand operation plane based on the parameters such as the size of the one-hand operation plane stored in memory 930 and the detection signal.

In another exemplary embodiment of the present disclosure, touch detecting unit 913 detects the sliding of the user's finger over touch screen 910 and sends a slide detection signal to processor 940. Processor 940 is configured to determine both the location and the size of the one-hand operation plane based on the slide detection signal, so that when the user holds the portable device system 900 with one hand, the entirety of the one-hand operation plane is touchable by any finger(s) of the user's hand holding portable device 500.

Then, when the user enables the one-hand operation by pushing a physical key/button 960 or pressing a GUI displayed on touch screen 910, or selecting an option from a list or a menu displayed on touch screen 910, the one-hand operation activating signal is sent to processor 940. Upon receiving the one-hand operation activating signal, processor 940 is configured to control touch screen 910 to perform either the one-hand GUI operation or the one-hand touchpad operation based on the parameters corresponding to the one-hand operation mode stored in memory 930 and the one-hand operation activating signal (Step 440). Then, when the user inputs the command of switching one-hand operation by either touch screen 910 or physical key/button 960, the switching signal is sent to processor 940, which is then configured to control touch screen 910 to perform another one-hand operation based on the switching signal and the parameters corresponding to the one-hand operation mode stored in memory 930 (Step 450). If the user changes the holding location and the change is detected by either touch detecting unit 913 or pressure detector 950, a new detection signal is sent to processor 940. Again, processor 940, after receiving the detection signal, is configured to determine the new location of the one-hand operation plane based on the new detection signal. The new location and the size of the one-hand operation plane are determined so that when the user holds portable device system 900 with one hand, the entirety of the one-hand operation plane is touchable by any finger(s) of the user's hand holding portable device 500.

It will be appreciated that the present disclosure is not limited to the exact construction that has been described above and illustrated in the accompanying drawings, and that various modifications and changes can be made without departing from the scope thereof. For example, even though the embodiments above are described with flat touch screens as examples, the present disclosure applies to touch screens of other shapes, such as foldable touch screens. It is intended that the scope of the disclosure only be limited by the appended claims.

What is claimed is:

1. A method for providing a one-hand user interface for a portable device with a touch screen, comprising:
defining a one-hand operation plane on the touch screen based on a holding location of the portable device when operated by a user;
enabling a one-hand operation mode; and
receiving user inputs through the one-hand operation plane for controlling the portable device.

2. The method of claim 1, wherein the one-hand operation mode includes a one-hand GUI operation mode or a one-hand touchpad operation mode.

3. The method of claim 2, further comprising switching between the one-hand touchpad operation mode and the one-hand GUI operation mode.

4. The method of claim 1, wherein the defining of the one-hand operation plane comprises defining a location of the one-hand operation plane.

5. The method of claim 1, wherein the defining of the one-hand operation plane comprises defining a size of the one-hand operation plane.

6. The method of claim 1, wherein the defining of the one-hand operation plane comprises:
detecting a sliding motion of a finger over the touch screen; and
defining the one-hand operation plane based on the detected sliding motion.

7. The method of claim 1, further comprising:
detecting a new holding location of the portable device; and
defining a new location of the one-hand operation plane on the touch screen corresponding to the detected new holding location.

8. The method of claim 1, wherein the portable device operates in a one-hand graphics user interface (GUI) operation mode after the activating of the one-hand operation, and wherein, in the one-hand GUI operation mode, at least one GUI is displayed within the one-hand operation plane to allow the user to operate the portable device.

9. The method of claim 8, wherein the at least one GUI includes at least one of a graphical icon or a virtual keypad.

10. The method of claim 8, wherein the at least one GUI corresponds to a program being executed when the one-hand operation mode is enabled or after the one-hand operation mode is enabled.

11. The method of claim 1, wherein the portable device operates in a one-hand touchpad operation mode after the enabling of the one-hand operation mode, and wherein, in the one-hand touchpad operation mode, the one-hand operation plane functions as a touchpad.

12. The method of claim 1, further comprising disabling a touch function of portions of the touch screen not within the one-hand operation plane after the one-hand operation plane is defined, so that the disabled portions of the touch screen do not respond to a press or a touch.

13. The method of claim 1, further comprising setting at least one parameter for the one-hand operation mode.

14. A portable device system, comprising:
a touch screen;
a memory that stores at least one parameter for a one-hand operation mode; and
a processor coupled to the touch screen and the memory, the processor being configured to:
define a portion of the touch screen as a one-hand operation plane based on a holding location of the portable device system;
enable a one-hand operation mode based on the at least one parameter for the one-hand operation; and
receive user inputs through the one-hand operation plane for operating the portable device system.

15. The system of claim 14, wherein the one-hand operation mode includes a one-hand GUI operation mode or a one-hand touchpad operation mode.

16. The system of claim 15, wherein the processor is further configured to switch the portable device system between the one-hand touchpad operation mode and the one-hand GUI operation mode.

17. The system of claim 14, wherein the processor defines the one-hand operation plane by defining at least one of a size or a location of the one-hand operation plane.

18. The system of claim 14, wherein the processor detects a sliding motion of a finger over the touch screen and defines the one-hand operation plane based on the detected sliding motion.

19. The system of claim 14, the processor is further configured to detect a new holding location of the portable device system and define a new location of the one-hand operation plane on the touch screen corresponding to the detected new holding location.

20. The system of claim 14, wherein the portable device operates in a one-hand graphics user interface (GUI) operation mode after the enabling of the one-hand operation mode, and wherein, in the one-hand GUI operation mode, at least one GUI is displayed within the one-hand operation plane to allow the user to operate the portable device.

21. The system of claim 20, wherein the at least one GUI includes at least one of a graphical icon or a virtual keypad.

22. The system of claim 14, wherein the portable device operates in a one-hand touchpad operation mode after the enabling of the one-hand operation mode, and wherein, in the one-hand touchpad operation mode, the one-hand operation plane functions as a touchpad and is configured to detect motions of a finger for controlling movements of a cursor displayed on the touch screen.

23. The system of claim 14, the processor is further configured to disable a touch function of portions of the touch screen not within the one-hand operation plane after the one-hand operation plane is defined, so that the disabled portions of the touch screen do not respond to a press or touch.

24. The system of claim 14, wherein the processor is further configured to set at least one parameter for the one-hand operation mode.

25. The system of claim 14, further comprising at least one sensor for detecting the holding location.

26. The system of claim 25, wherein:
the sensor is configured to generate a pressure signal representing a pressure applied to the touch screen by the user; and
the processor is further configured to determine, based on the pressure signal,
whether the finger of the user touches a new location of the touch screen.

27. The system of claim 26, wherein the processor is further configured to determine, based on the pressure signal, whether a change in the pressure exceeds a threshold value, and adjust the location of the one-hand operation plane corresponding to the new location when the change in the pressure exceeds the threshold value.

28. The system of claim 26, wherein the processor is further configured to determine, based on the sensor, whether the pressure at the new location is maintained for at least a period of time and adjust the location of the one-hand operation plane corresponding to the new location when the pressure at the new location is maintained for at least a period of time.

29. The system of claim 14, wherein the processor is further configured to receive at least one command for enabling the one-hand operation mode.

30. The system of claim 14, wherein the portable device system is a smart phone or a tablet PC.

31. The system of claim 14, further comprising an orientation sensor configured to detect an orientation of the portable device system, and
wherein the processor is further configured to adjust the one-hand operation plane based on the orientation of the portable device system.
